(19) United States
(12) Patent Application Publication
(10) Pub. No.: US 2009/0079412 A1
(43) Pub. Date: Mar. 26, 2009

(54) Apparatus and method for controlling the output of a photovoltaic array

(76) Inventor: Yao Hsien Kuo, West Bloomfield, MI (US)

Correspondence Address: PAUL K. GODWIN;Paul K. Godwin, P.C., 7218 Pine Vista Dr., Brighton, MI, 48116, US

(21) Appl. No.: 11/903,983

(22) Filed: Sep. 24, 2007

(51) Int. Cl. G05F 5/00; G05D 17/02; H02J 7/35

(52) U.S. Cl. 323/299; 136/293; 320/101; 700/297

(57) ABSTRACT

An array of photosensitive devices, including photovoltaic cells is controlled to provide adequate output voltage for continued use when light conditions are sensed as dropping below a predetermined level for normal operations. Control is made of the internal connections between banks of devices or cells by switching normally parallel connected banks of series connected devices or cells to series connected banks. Stepped switching of an increased number of banks can be made as the light continues to drop, in order to extend and maximize the output of the array during reduced light conditions. The output can be further controlled to limit application of the output voltage to a load during times of diminished light conditions in order to not overdraw the diminished current capacity characteristics when the series connections are made.

### BACKGROUND

1. Field of the Invention

The invention relates generally to the field of photo sensitive detectors and more specifically to the area of controlling the output of such detectors when provided to a load.

2. Description of the Prior Art

A photosensitive detector is generally known as a device that senses light and provides an output response. It uses the principle of photoconductivity, which is exhibited in certain materials that change their electrical conductivity when exposed to radiant energy, which can be in various ranges of the light spectrum including infrared and ultraviolet as well as the visible range. Examples of photosensitive detectors include photoconductive cells, photodiodes, photoresistors, photoswitches, phototransistors, phototubes, nano-wires and photovoltaic cells.

Photovoltaic (“PV”) cells are well known photosensitive devices that are widely used in the field of electrical energy production because they are able to produce known quantities of electrical energy when exposed to sufficient levels of light energy. When individual PV cells are connected together in a series arrangement, the output from each cell is added to the others in the series to produce a desired voltage that is used to provide power to a load. A grouping of series connected PV cells is usually referred to as a bank of cells. In order to provide a desired current capacity at the desired voltage, several banks of PV cells are usually connected in parallel to form an array of PV cells having both a desired voltage output characteristic and a desired current capacity or maximum current rating.

When used in battery charging systems, PV cells cease to provide sufficient charging voltage when the strength of light energy incident on the surface of the PV cells drops below a predetermined level and the output voltage of PV cells is lower than the battery charging threshold voltage. If PV cells are used to provide output directly to a charging battery, the output voltage of the PV cells must be higher than the fully charged battery voltage in order to charge the rechargeable battery. In some cases, a DC-DC converter is used to convert the output voltage from PV to the proper voltage to charge the battery. However, the PV cells must still provide voltage output that meets or exceeds the minimum input threshold-voltage requirement for a DC-DC converter to function.

Prior to the present invention, control systems for PV cells and other photosensitive devices would shut down or switch to back up systems when the light energy incident on them dropped sufficiently to cause the voltage output to drop below a predetermined threshold.

### SUMMARY OF THE INVENTION

The present invention provides apparatus and method for controlling the output of an array of photosensitive devices when the level of incident light energy on the devices drops below a minimum threshold level. Control is achieved primarily by switching the connections of a number of device banks from parallel to series in order to boost the output voltage in low light conditions. Additional control in such conditions can be made by increasing the number of switched connections as the light drops to lower levels. Such switching extends the useful capabilities of the devices beyond the higher light dependent conditions.

An object of the present invention is to provide a system for controlling the output of an array of devices, such as photovoltaic cells, that are connected in banks to provide a voltage output of at least a predetermined level when exposed to at least a predetermined level of light energy. The banks of devices are connected together in parallel to provide a predetermined level of current capacity to a load. A sensor is connected to the output of the array of devices to sense when the output voltage level drops to a level that indicates the output is diminishing due to reduced exposure to light energy. A switching device is connected to the sensor to switch banks of devices from parallel to series connections in order to boost the output voltage level as exposure to light energy drops below the predetermined level. This switching action is able to extend the usable dynamic ranges of photo sensitive devices over a wider variation of light strength.

Another object of the present invention is to provide a method of regulating the output of an array of photovoltaic cells when the exposure of the array to radiant light energy falls below a predetermined light energy level and the corresponding output voltage from the array is reduced below a predetermined level. The method includes: the step of connecting individual photovoltaic cells in series in sufficient number to provide an output voltage above the predetermined level; the step of connecting a plurality of the series connected cells in parallel to provide an output voltage at a predetermined current capacity for a load connected to the array; the step of sensing the output voltage of the array and providing a first switching signal when the output voltage drops below the predetermined level due to decreased exposure of the array to light energy radiation; the step of connecting a first switch element to the parallel connected cells; and the step of making the switch element responsive to the first switching signal to change a first number of the parallel connected cells to a series connection in order to sustain at least a desired output voltage as the exposure of the array to light energy radiation drops below the predetermined light energy level.

The detailed description is directed to a photovoltaic cell array but is deemed to be equally applicable to other arrays of photosensitive devices which provide output voltages related to the amount of light energy radiation incident on the array.

### BRIEF DESCRIPTION OF THE DRAWINGS

FIG. 1 is a plot of voltage output vs. light levels incident on a PV cell array containing the present invention

FIG. 2 is a schematic of a PV cell array containing the switching elements of the present invention in a normal operating condition under normal light levels.

FIG. 3 is a schematic of a PV cell array containing the switching elements of the present invention in a first switched condition under low light levels.

FIG. 4 is a schematic of a PV cell array containing the switching elements of the present invention in a second switched condition under lower light levels.

FIG. 5 is a schematic of the present invention illustrating a PV cell array with integrated transistor switch elements and a charge controller.

FIG. 6 is a conceptual cross-sectional view of a PV cell containing an integrated transistor switch element.

FIG. 7 is a schematic of a controller embodiment for the present invention.

FIG. 8A is a plot of voltage accumulator and discharge from an output accumulator capacitor shown in FIG. 7.

FIG. 8B is a plot of voltage output at intervals corresponding to the switched discharge of output accumulator capacitor plotted in FIG. 8A.

FIG. 9 is a schematic of a level shift driver buffer relay as may be used in an embodiment of the present invention.

FIG. 10 is a flow chart showing the first portion of a control algorithm as may be used in an embodiment of the present invention.

FIG. 11 is a flow chart of the second portion of a control algorithm as may be used in an embodiment of the present invention.

### DETAILED DESCRIPTION OF THE PREFERRED EMBODIMENT

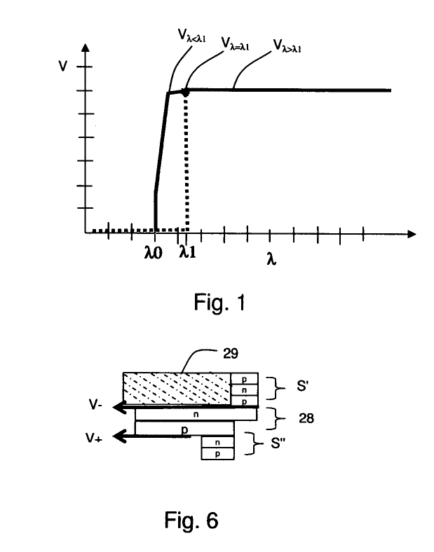

FIG. 1 is a plot of output voltage “V” from a battery charger connected to an array of PV cells vs. incident light “A” on the array. The plot illustrates a typical plot of no voltage output (horizontal dashed line) when the incident light energy on the PV cell array is below a predetermined light energy threshold level λ1 (vertical dashed line). When the PV cell array is exposed to incident light energy at or above λ1 the output voltage V jumps to a value of V_{λ=λ1} and stays at that level for all light levels above that threshold value V_{λ>λ1}.

In FIG. 1, the effect of the present invention is illustrated as boosting or enhancing the output of the PV cell array when the incident light energy levels incident on the array drop below λ1. Through the switching apparatus and method described below, it is possible to extend the usefulness of the PV cell array to continue to produce voltage and operate when exposed to lower light energy levels. The plot of output voltage V_{λ<λ1} shown to the left of λ1 illustrates the advantage of the present invention by extending the useful output voltage at lower light energy levels.

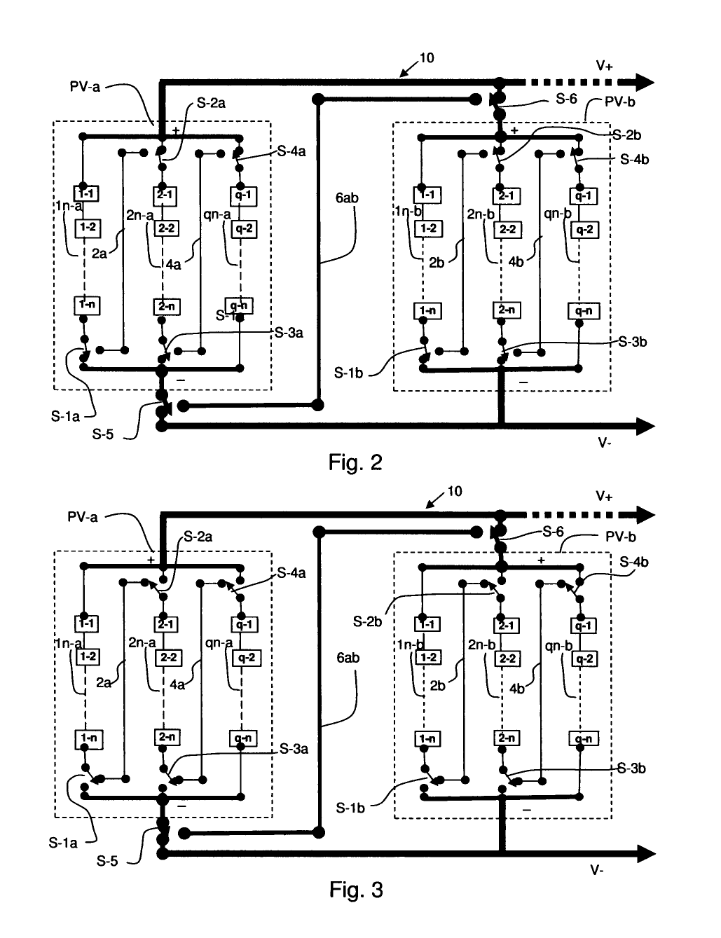

FIG. 2 illustrates an embodiment of the present invention incorporated into a typical PV cell array or matrix 10. Sub-arrays PV-a and PV-b each contain a plurality of PV cells 1-1 through q-n. In sub-array PV-a, a first bank of PV cells 1n-a comprises series connected cells 1-1 through 1-n, as is typical to provide a desired output voltage level for the bank. Other banks 2n-a through qn-a are identical to the first bank and the banks are connected in parallel with each other and in quantity to provide a desired current capacity for a load that is expected to be connected between output terminals indicated at V+ and V−.

Each sub-array in FIG. 2 contains a plurality of switches for implementing the present invention. In sub-array PV-a, switch S-1a is connected to the negative terminal of bank 1n-a and is shown there to be normally positioned for connection to the negative bus. Switch S-2a is connected to the positive terminal of bank 2n-a and is shown there to be normally connected to the positive bus. A lead 2a contains end terminals which are used in the switching that takes place when implementing the present invention. The end terminals of lead 2a are respectively connected to switch S-1a and S-2a, as shown in the Figure. Similarly, switches S-3a and S-4a are respectively connected to the negative end of bank 2n-a and the positive end of bank qn-a. These switches are also shown in their normal positions of connecting each bank in parallel with others in the sub-array PV-a. A lead 4a contains end terminals which are used in the switching that takes place when implementing the present invention. The end terminals of lead 4a are respectively connected to switches S-3a and S-4a, as shown in the Figure.

As can be seen in FIG. 2, sub-array PV-b is identical in content to sub-array PV-a. In sub-array PV-b, a first bank of PV cells 1n-b comprises series connected cells 1-1 through 1-n, as is typical to provide a desired output voltage level for the bank. Other banks 2n-b through qn-b are identical to the first bank and the banks are connected in parallel with each other and in quantity to provide a desired current capacity for a load that is expected to be connected between output terminals indicated at V+ and V−. In sub-array PV-b, switch S-1b is connected to the negative terminal of bank 1n-b and is shown there to be normally positioned for connection to the negative bus V−. Switch S-2b is connected to the positive terminal of bank 2n-b and is shown there to be normally connected to the positive bus V+. A lead 2b contains end terminals which are used in the switching that takes place when implementing the present invention. The end terminals of lead 2b are respectively connected to switch S-1b and S-2b, as shown in the Figure. Similarly, switches S-3b and S-4b are respectively connected to the negative end of bank 2n-b and the positive end of bank qn-b. These switches are also shown in their normal positions of connecting each bank in parallel with others in the sub-array PV-b. A lead 4b contains end terminals which are used in the switching that takes place when implementing the present invention. The end terminals of lead 4b are respectively connected to switches S-3b and S-4b, as shown in the Figure.

Also in FIG. 2, an interconnecting lead 6ab is provided in array 10 to provide a switched series connection of sub-array PV-a to sub-array PV-b by additional switches S-5 and S-6. Switches S-5 and S-6 are shown in FIG. 2 as being in their normal positions of connecting the negative side of sub-array PV-a to the V− bus and the positive end of sub-array PV-b to the V+bus.

The schematic shown in FIG. 3 is identical to the schematic shown in FIG. 2, except that switches S-1a, S-2a, S-3a and S-4a of sub-array PV-a are thrown to connect the banks 1n-a, 2n-a through qn-a, that make up sub-array PV-a, in series with each other. This is achieved by using switches S-1a and S-2a to disconnect the negative end of bank 1n-a from bus V−, disconnecting the positive end of bank 2n-a from the bus V+ and connect those ends together via lead 2a. Similar reconnections are made via switches S-3a and S-4a with respect to banks 2n-a and qn-a and lead 4a.

Sub-array PV-b shown in FIG. 3 is likewise reconfigured, since it remains connected in parallel with sub-array PV-a. Switches S-1b, S-2b, S-3b and S-4b of sub-array PV-b are thrown to connect the banks 1n-b, 2n-b through qn-b, that make up sub-array PV-b, in series with each other. This is achieved by using switches s-1b and S-2b to disconnect the negative end of bank 1n-b from bus V−, disconnect the positive end of bank 2n-b from the bus V+ and connect those ends together via lead 2b. Similar reconnections are made via switches S-3b and S-4b with respect to banks 2n-b and qn-b and lead 4b.

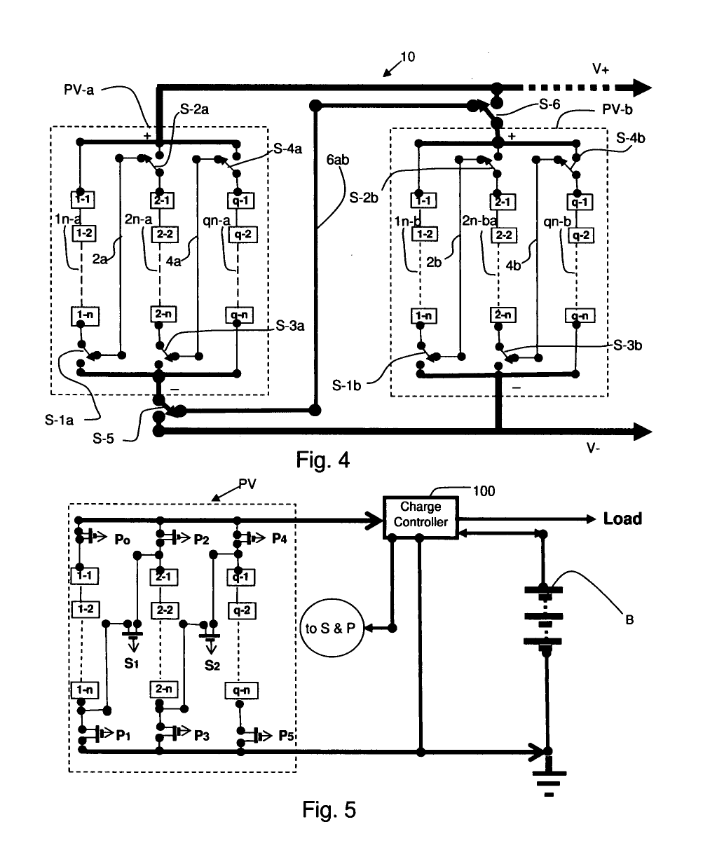

The schematic in FIG. 3 illustrates a first reconnection of the PV cells in an array that can be made when the voltage at the output, is sensed as being below a predetermined level, due to a decreased exposure to light energy. Since such a drop in voltage adversely affects the performance characteristics of the array 10 as an electrical energy source, the reconfiguration shown in FIG. 3 provides more series connections of cells, with each generating a less than normal voltage under the diminished light energy conditions. This continues until such time that the energy level returns or drops to a further lower threshold level. In the event the level of light energy exposure continues to drop, the array 10 can be further reconfigured by switching as shown in FIG. 4.

The schematic shown in FIG. 4, is identical to the schematic shown in FIG. 3, except that switches S-5 and S-6 are thrown to disconnect sub-arrays PV-a and PV-b from their normal parallel connection and reconfigure them in a series connection to each other through lead 6ab.

The schematics shown in FIGS. 2-4 illustrate all the switches as conventional representations. However, it should be understood that such switches can be implemented in other ways including solenoids and solid state devices.

FIG. 5 is a schematic of a PV array that employs solid state devices to perform switching of the individual banks of cells from parallel to series configurations when directed by a controller 100. In this schematic, the controller 100 functions to monitor and sense the output voltage provided from the PV array as such output is sourced to charge rechargeable battery B and any other loads that may be connected. The PV array, in this case, utilizes solid state switching devices represented as P0, P1, P2, P3, P4 and P5. By controlling the on-off states of the switching devices, the controller 100 can reconfigure the banks from their normal parallel connections to the desired series connections necessary to provide the desired output in diminishing light exposure conditions and to restore the parallel connections when the amount of light energy incident onto the array is restored to a predetermined level.

It is further contemplated that the solid state switching devices can be created directly on the PV array substrate, as shown in FIG. 6. In that illustration, the PV cell is represented as n-p junction 28 with a transparent protective coating 29 deposited thereon. Switches S′ and S″ are shown as p, n and p doped layers formed on each of the n and p layers that define the PV cell 28. Several variations of this configuration could also be used to implement the concept described herein.

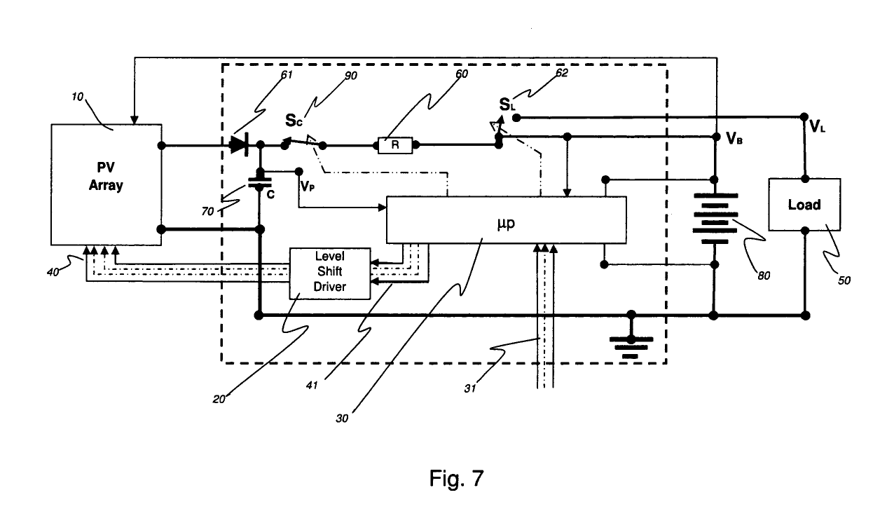

In FIG. 7, a more detailed schematic is provided of the charge controller 100 represented in FIG. 5. In this schematic, controller 100 contains a microprocessor 30, a charge accumulation device (capacitor) 70, a rectifier (diode) 61, relay switch 90 a resistor 60 a load switch 62 and a shift level driver 20. Controller 100 is connected to receive the electrical output from the PV array 10 and to pass it to a battery 80 and/or other loads 50, as desired. Microprocessor 30 is shown with inputs Vp representing the accumulation voltage present at capacitor 70, Vo representing the output voltage delivered to the load, and load control settings at 31. Microprocessor 30 is shown with outputs 41 to control the shift level driver 20 and the internal switching that takes place inside the PV array 10 when light energy levels fall below the predetermined levels for normal operation. Microprocessor 30 also has an output for controlling switch Sc (90) when the output voltage from the PV array 10 is so low that it cannot sustain continuous current draw by the loads. Through appropriate pwm control of switch Sc (90), the accumulation charge from the capacitor can be transferred to the load. Switch 62 represents a load control switch that is manually controlled to add or subtract loads from the system as appropriate.

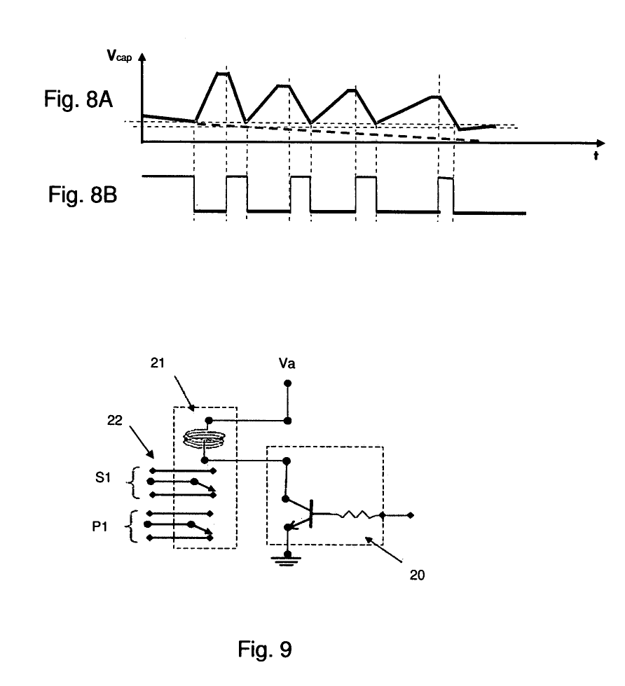

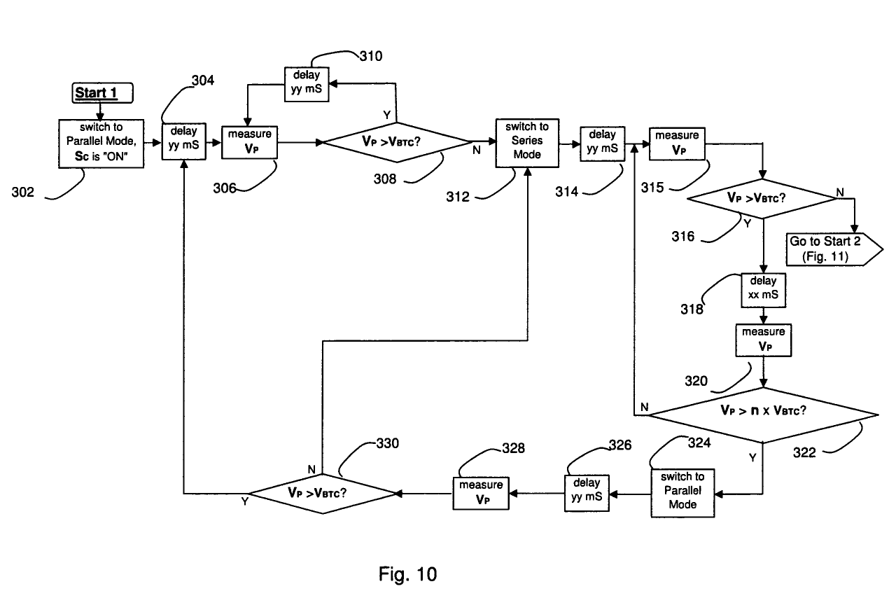

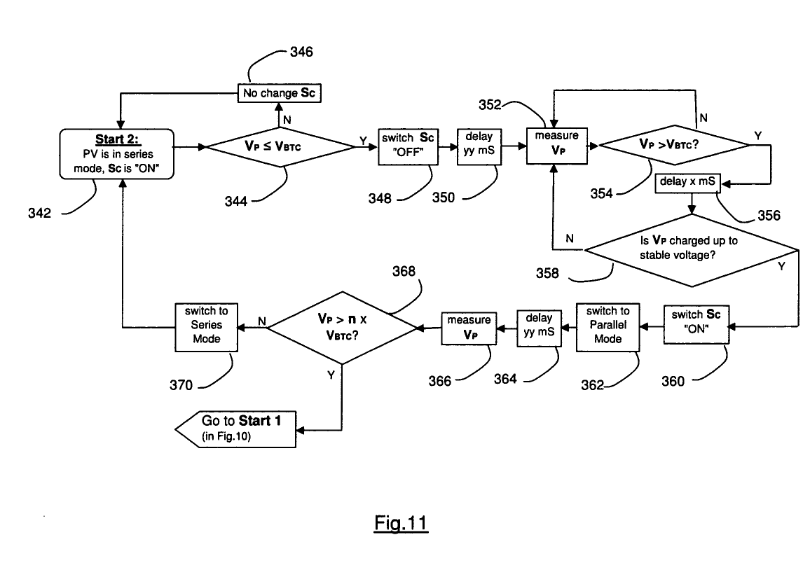

The on-off switching of relay switch Sc (90) by microprocessor 30 is illustrated in FIGS. 8A and 8B. As will be more clear after the discussion of the algorithms in FIGS. 10 and 11, the application of pulse width modulation (“pwm’) in FIGS. 8A and 8B to the load is only made when the output voltage is still measurable from PV array 10 but is so low, after switching as many cells as practical to series connections, that it cannot be connected directly to the load without overdrawing current from the cells. In this situation, switch 90 is opened by microprocessor 30 until the output voltage from PV array 10 is accumulated in capacitor 70 to a predetermined level that is equal to that which can be applied to the load. At that point, switch 90 is closed and capacitor 70 discharges through resistor 60 to rechargeable battery 80 and/or load 50. The rectifier 61 acts to prevent the accumulated voltage from returning to the PV array 10.

While FIG. 8A shows the accumulating and discharging of charge in capacitor 70, FIG. 8B shows the corresponding voltage applied to the load in pulses of predetermined amplitude but durations between pulses vary according to the time it takes for the charge to accumulate to a predetermined level in capacitor 70. Likewise, the duration of each pulse is controlled by the time it takes for the accumulated charge to discharge through the resistor 60 and the connected load.

Since the current and voltage switching capabilities of most microprocessors are quite small, switching of switch elements that are subject to higher amounts of current or voltage are handled by level shift driver buffers. One such driver 20 is represented in FIG. 7 and detailed in FIG. 9. Driver 20 is made up of a transistor 20a which is connected to a coil 23 of a relay 21. Relay 21 further includes a set of contacts 22 that are connected to switching elements in the PV array, exemplified in FIG. 9 as switches S1 and P1 in FIG. 5. When energized by a signal from the microprocessor 30 to the base of transistor 20a, the transistor switches from a normally high impedance state to a low impedance state and allows current from source Va to flow through coil 23 and, by electromagnetic force, shift contacts 22 from their normal states to an activated state.

The algorithm or program employed in the present invention to control the switching of the banks of PV cells is shown in flow diagrams in FIGS. 10 and 11. The first portion of the program is described with respect to FIG. 10, where determinations are made concerning the condition of the output voltage from the PV cell array and when to cause the switching elements within the array to reconnect a number of PV cell banks from their normal parallel configurations to a series configuration and then back again. The program presented in FIGS. 10 and 11 provides for a first level switching of banks of PV cells from parallel to series. It is intended to serve as the basis for more extensive programs that provide switching of different numbers of banks at different measured levels of output from the array.

Beginning at Start 1 point, the program confirms that the PV cells are in their normal parallel modes and that the switch Sc (90) is closed in step 302. A predetermined time delay “yy” (in milliseconds) is provided at step 304. Following the time delay, measurement of the voltage Vp occurs at step 306. A determination is made at step 308 to see if the Vp measurement is greater than Vbtc. Vbtc is defined as the minimum threshold voltage for which a battery can be charged (the minimum charging voltage). If the voltage Vp is greater than Vbtc, then a delay step is invoked at 310 and measurements and determinations are repeated in the loop of steps 306, 308, 310. At such time that the voltage Vp is determined to not be greater than Vbtc at step 308, such as when the incident light energy falls below a predetermined level, the instruction is made at step 312 to switch banks of PV cells from parallel to series connections. Another delay is invoked at step 314 and the voltage Vp is again measured at step 315.

Another determination is made at step 316 to determine if the value of Vp measured at step 315 is greater than Vbtc after the switching of the PV cells to a series mode has been made at step 312. If the determination at step 316 was that Vp measured at step 315 was not greater than Vbtc, the program enters the second part of the algorithm shown in FIG. 11 and explained below. If, however, the Vp is determined at step 316 to be above Vbtc due to switching the PV cells to a series configuration in step 312, another delay is imposed at step 318 and the voltage Vp is again measured at step 320. Following the measurement step 320, the value of Vp is compared with a value n×Vbtc, where n is defined by charging current characteristics of the battery 80 and resistor 60 shown in FIG. 7. Generally, n is in the range of 1.5 to 4. If the value of Vp is determined to not be greater, then the program returns to step 315 while leaving in place the series connection of the banks of PV cells made in step 312. If the value of Vp is determined to be greater in step 322, such determination indicates that the voltage is again stable and the banks of PV cells are restored to their normal parallel connection in step 324. Subsequent steps of measuring Vp and determining measured values at steps 328 and 330 allow the program to continually check for deteriorating output of the PV cell array and to make appropriate switching of PV cell banks from parallel to series connections as appropriate for deteriorating light exposure.

FIG. 11 shows the second portion of the algorithm program extending from FIG. 10 at step 316. In the second portion of the program, determinations are made as to whether and how to apply pulse width modulation techniques to feed the output voltage to the battery load in order to continue to affect a useful charging voltage, when the PV cells are connected in series and the output has further diminished due to low light energy levels.

The start point 342 indicates that banks of PV cells are connected in series, per step 312. The value of Vp measured at step 315 is compared at step 344 to see if it is equal to or below Vbtc. If it is not, then step 346 confirms that Switch Sc (90) in FIG. 7 should remain in its normally closed “on” state. However, if step 344 determines that the value of Vp is less than or equal to Vbtc when the PV cells are in series, this indicates that there is a need to enter the pwm mode and switch Sc (90) is switched to its open “off” state. Such switching is performed at step 348. After a delay at step 350, the value of Vp is measured at step 352. A determination is made at step 354 to see if the value of Vp measured at step 352 is greater than Vbtc. If not, the program returns to step 352. If the value at step 354 is determined to be greater, after a delay at step 356, a determination is made at step 358 as to whether Vp is stable. This is done be repeated samplings/measurements of Vp to determine if the value remains constantly above Vstc for a predetermined period of time. If the Vp is determine to not be stable, switch Sc (90) remains off. At such point that Vp is determined to be stable in step 358, switch Sc (90) is closed in step 360 to allow the voltage accumulated in capacitor 70 to be discharged to the rechargeable battery 80 and/or load 50. This is shown in FIG. 8B as a single pulse having a width duration that extends from step 360 through to step 348 and is repeated until such time that there is insufficient accumulation of charge in capacitor 70 that prevents step 360 from being performed.

Following the closing of switch Sc (90) in step 360, the banks of PV cells are switched back to parallel mode in step 362. After a delay in step 364 and measurement of Vp in step 366, a determination is made in step 368 of whether Vp is greater than n×Vbtc to determine if Vp is stable. If not stable, banks of the PV cells are switched to a series configuration in step 370. This may include more or less numbers of banks of PV cells than the earlier switching at step 312, depending on the design of the system. Upon switching to series mode at step 370, the second part of the program is repeated starting at step 342. If it is determined that Vp is stable at step 368, the array of PV cells remains in its normal parallel configuration as set in step 362 and the program returns to the beginning at Start 1 in FIG. 10.

It should be understood that the foregoing description of embodiments is merely illustrative of many possible implementations of the present invention and is not intended to be exhaustive.

I claim:

1. A system for controlling the output of an array of photo sensitive devices comprising:
said array of photo sensitive devices connected in banks to provide a voltage output of at least a predetermined level when exposed to at least a predetermined level of light energy;
said banks of devices are connected together in parallel to provide a predetermined level of current capacity to a load;
a sensor connected to the output of said array of cells to sense when said output voltage level drops to a level that indicates said output is diminishing due to reduced exposure to light energy; and
a switching device connected to respond to said sensor to switch banks of devices from parallel to series connections in order to boost the output voltage level as said exposure to light energy drops below said predetermined level.

2. A system as in claim 1, wherein said sensor and said switching device are integrated in a transistor.

3. A system as in claim 1, wherein said array of photosensitive devices is an array of photovoltaic cells and said sensor and said switching device are integrated into the structure of said photovoltaic cells.

4. A system as in claim 1 wherein said switching device is a relay.

5. A system as in claim 1, wherein said switch element switches a first predetermined number of said banks of devices to a series connection in order to sustain a desired output voltage level as said exposure to light energy radiation drops below said first predetermined light energy level.

6. A system as in claim 5, wherein said sensor is connected across said load to sense when said output voltage level drops to a level that is below said predetermined level.

7. A system as in claim 5, wherein said sensor is a microprocessor that senses a decrease in output voltage and reacts to provide a switch signal when said voltage drops below said predetermined level.

8. A system as in claim 1, wherein said switch element provides a primary switching of a first number of said banks of devices of said array to be in series when said light level drops below said first predetermined light energy level, and provides a secondary switching of a second number of banks of devices of said array to be in series when said light energy level drops below a secondary predetermined light energy level below said first predetermined light energy level.

9. A microprocessor controlled system for regulating the output of an array of photovoltaic cells when the exposure of said array to radiant light energy falls below a predetermined light energy level and the corresponding output voltage from said array is reduced below a predetermined level, comprising:
individual photovoltaic cells being connected in series in sufficient number to provide an output voltage above said predetermined level and a plurality of said series connected cells connected in parallel to provide an output voltage at a predetermined current capacity for a load connected to said array;
a microprocessor connected to said array for sensing the output voltage of said array and being programmed to provide a first switching signal when the output voltage drops below said predetermined level; and
a first switch element connected to said parallel connected cells, whereby said switch element being responsive to said first switching signal to change a first number of said parallel connected cells to a series connection in order to sustain a desired output voltage as the exposure of said array to light energy radiation drops below said predetermined light energy level.

10. A system as in claim 9, wherein a charging element is connected across the output of said array and a second switching element is connected between the charging element at said output of said array and said load to provide a normally closed path between said array and said load, and to provide an open path in response to a second switching signal from said microprocessor; said microprocessor is further programmed to provide periodic sensing of said output voltage and after said first switching signal is generated and provides a second switching signal when said output voltage at said charging element is below said desired output level.

11. A system as in claim 10, wherein said microprocessor is further programmed to function to provide a cessation of said second switching signal when said output voltage at said charging element reaches said desired level condition to thereby allow said second switching element to close said path to said load, and to repeat the sequential providing and cessation of said second switching signal as output voltage conditions repeat themselves.

12. A system as in claim 9, wherein said first switch element causes said first number of said changed cells to assume their original parallel connections when said output voltage is determined by said microprocessor to be above the predetermined level for a predetermined period of time.

13. A method of controlling the output of a array of photo sensitive devices formed of banks of series connected devices to provide a voltage output of at least a predetermined level when exposed to at least a predetermined level of light energy and said banks of devices are connected together in parallel to provide a predetermined level of current capacity to a load, comprising the steps of;
sensing the output of said array of devices to determine when said output voltage level drops to a level that indicates said output is diminishing below said first predetermined level; and
switching banks of devices from parallel to series connections in order to boost the voltage output level as said exposure to light energy drops below said predetermined level.

14. A method as in claim 13, further comprising the steps of:
primarily switching a first number of banks of devices of said array to be in series when said output voltage level drops below said first predetermined level; and
secondarily switching a second number of remaining parallel connected devices of said array to be in series when said output voltage level subsequently drops below said first predetermined level.

15. A method of regulating the output of an array of photovoltaic cells when the exposure of said array to radiant light energy falls below a predetermined light energy level and the corresponding output voltage from said array is reduced below a predetermined level, comprising the steps of:
connecting individual photovoltaic cells in series in sufficient number to provide an output voltage above said predetermined level;
connecting a plurality of said series connected cells in parallel to provide an output voltage at a predetermined current capacity for a load connected to said array; sensing the output voltage of said array and providing a first switching signal when the output voltage drops below said predetermined level; and
connecting a first switch element to said parallel connected cells, and making said switch element responsive to said first switching signal to change a first number of said parallel connected cells to a series connection in order to sustain at least a desired output voltage as the exposure of said array to light energy radiation drops below said predetermined light energy level.

16. A method as in claim 14, further including the steps of:
connecting a charging element across the output of said array;
connecting a second switching element between the charging element at said output of said array and said load to provide a normally closed path between said array and said load, and to provide an open path in response to a second switching signal;
periodically sensing said output voltage and, if said first switching signal is generated generating a second switching signal when said output voltage at said charging element is again below said desired output level.

17. A method as in claim 16, further including the steps of:
ceasing the generation of said second switching signal when said output voltage at said charging element is sensed to have reached said desired level condition and allow said second switching element to close said path to said load, and to repeat said sensing and switching steps as output voltage conditions repeat themselves.

18. A method as in claim 17, further including the step of:
resetting said first and second switch elements to their normal states when the output of said array is below said desired output level continuously for a defined period of time.

19. A method as in claim 15, further including the step of:
restoring said changed first number of cells from series to their original parallel connections when said output voltage is sensed output voltage is determined to be above the predetermined level for a predetermined period of time.

20. A method as in claim 19, further including the steps of:
programming a microprocessor to provide the functions of sensing said output voltage;
determining when said output voltage drops below a predetermined level, and
providing a first switch signal to said first switch element.
